(19) United States
(12) Patent Application Publication
(10) Pub. No.: US 2013/0084365 A1
(43) Pub. Date: Apr. 4, 2013

(54) EDIBLE TOY

(71) Applicant: Chaim Bassan, Ramat Gan (IL)

(72) Inventor: Chaim Bassan, Ramat Gan (IL)

(21) Appl. No.: 13/521,746

(22) PCT Filed: Jan. 19, 2011
(86) PCT No.: PCT/IL11/00057

§ 371 Date: Jul. 12, 2012

Related U.S. Application Data
(60) Provisional application No. 61/296,267, filed on Jan. 19, 2010.

(51) Int. Cl. A63H 33/10; A23L 1/16

(52) U.S. Cl. CPC A63H 33/108; A23L 1/16
USPC 426/104

(57) ABSTRACT

A toy article comprising at least one connection element and being made of a material configured to be rigid when in a dry state and flexible after being wetted, and being edible.

C

### FIELD OF THE INVENTION

This presently disclosed subject matter relates to the field of edible toy articles.

### BACKGROUND OF THE INVENTION

Edible toys are generally food products that are used for entertainment, art and other activities and which may be consumed by people or animals, at least partially and at least at some stage of their life.

### SUMMARY OF THE INVENTION

The presently disclosed subject matter relates to a toy article comprising at least one connection portion and being made of a material configured to be rigid when in a dry state and flexible after being wetted, and being edible.

The term wetted as used herein the specification and claims denotes any process resulting in moistening, such as wetting, soaking, boiling, cocking, steaming.

The toy article can comprise at least one connection portion configured for connection to at least one edible element. The toy article can comprise one or more connection portions.

The connection portions can be configured for coupling by different mechanisms, for example, male or female characteristics, bayonet or screw coupling, etc. Each toy article can be configured with several coupling elements of like or different configurations.

The edible element can assume different shapes and be configured with one or more coupling positions for articulation to connection portions of the toy article.

The toy element can be made, for example, of pasta. The edible element may also be made, as an example, of pasta. The pasta can be made for example on the basis of different flour, rice or sugar.

Furthermore, the edible elements may be straight elongate elements (e.g. spaghetti/macaroni rods) or otherwise shaped.

In some examples of the presently disclosed subject matter, the toy article and the can be edible only after cooking thereof. The cooking process can include placing the toy article and edible element in hot water or steam. During the cooking process, the toy article can be connected to at least one edible element, at least some of the time, for example, when initially placed in a pot.

In some further example of the presently disclosed subject matter, the force that is required to disconnect the edible element from the connection portion, when it is connected thereto, is greater after the connection portion is wetted than when it is dry.

In still further examples of the presently disclosed subject matter, the connection portion may not adhere to the edible element when it is dry and may at least partially adhere to the edible element after it is wetted. Evenmore so, once wetted, and after drying, the articulated toy elements and the edible elements become integrated with one another, i.e. adhered to one another. Such adhesion takes place also owing to gluten and/or sugar serving as a bonding agent between the toy elements and the edible elements.

According to a particular example, coupling between the connection portion and the edible element takes place by a receptacle formed at the connection portion sized for receiving a range of sized/shaped edible elements. For example the receptacle can be configured with a tapering receptacle configured for receiving a range of edible elements having a nominal size or a circumcircle ranging between the maximal and minimal diameter of the receptacle.

According to a particular example, the toy element is configured with a tapering cylindrical receptacle constituting a connection portion fitted for attaching thereto a variety of tubular pasta (spaghetti/macaroni) rods.

The toy article can be part of a toy set comprising a plurality of toy articles in different shapes and forms. The toy set can be packaged separately from or together with the edible elements. For example, a common package subdivided into a portion housing the set of toy articles and a portion housing edible elements, for example, pasta. The toy set can be used, for example, as part of an assembly set together with themselves and/or with the edible elements. The set can be fully consumed later on and is thus environmentally-friendly.

In some examples of the presently disclosed subject matter, the toy articles can comprise dough material. The term “dough” as used herein refers to a soft, thick mixture of dry ingredients (such as meal or cereal flour, sugar, powdered leguminous crops) and liquid (such as water, oil, egg white, egg yolk, alcohol etc.). The dough material can be used as a toy article, as a portion thereof or as a connecting element for connection of two or more toy elements. When the toy articles are connected, the connection may be accomplished either by using the dough material as a connecting element or alternatively, the ends of the toy articles made of dough are connected to each other either in a wet state or in a dry one. Thus, the elements can be, for example, permanently connected without the use of any non-edible adhesives and the assembly set remains fully consumable and environmentally clean.

The toy articles can be used to build models having any shape or size, even a number of meters in height. Assembly instructions can be attached in a package together with the set and instruct users how to construct model(s) with the use of the toy articles, including, for example, well known models such as an airplane, a house, a ship, etc. Assembly instructions can also be published in a web-site, including the ability to design custom models on-line and saving them to the web-site for use by others.

The toy articles can be packaged separately from or together with ordinary off-the-shelf or custom edible elements.

The toy articles can be colored as part of their production process and/or by a user of the toy article s in various colors, for example, by ink, water colors, acrylic colors, food colors, etc. The color(s) can be attached in the package with the toy articles.

Connection between the toy articles and the edible elements or between themselves can be reinforced by wetting the toy articles and/or the edible element, for example, by water, saliva, oil or any other liquid or vapor of a liquid prior to and/or after connection, and subsequently drying them either actively or simply by waiting for them to dry.

The toy articles and connection elements can be of various shapes and/or sizes, for example, significantly smaller in size than the edible elements and/or significantly larger than the edible elements.

Assembly of the toy articles with the edible elements, can be for any purpose, some examples are: entertainment, education, marketing of the toy articles and/or the edible elements, shop displays, art, culinary ornamentation, special dishes, etc.

Each toy article can be configured with one or more connection elements at any location, e.g. at end portions thereof, or anywhere else.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A and 1B show examples of edible products;

FIG. 1C shows an example of a toy article according to the presently disclosed subject matter, with an exemplary female connection end;

FIG. 1D shows an example of a toy article according to the presently disclosed subject matter, with an exemplary male connection end;

FIG. 1E shows another example of a toy article according to the presently disclosed subject matter, with an exemplary tapering female connection end;

FIGS. 2A to 2K show different examples of toy articles according to the presently disclosed subject matter;

FIGS. 3A to 30 show further different examples of toy articles according to the presently disclosed subject matter;

FIG. 4 shows a model of a house assembled by using exemplary toy articles according to the presently disclosed subject matter and pasta;

FIGS. 5A to 5D show cross-sections of connector portions of some further examples of toy articles according to the presently disclosed subject matter;

FIG. 6 shows an exemplary toy article in the form of a rectangular plate with connection ends configured for placement therein of shell pasta.

### DETAILED DESCRIPTION OF EMBODIMENTS

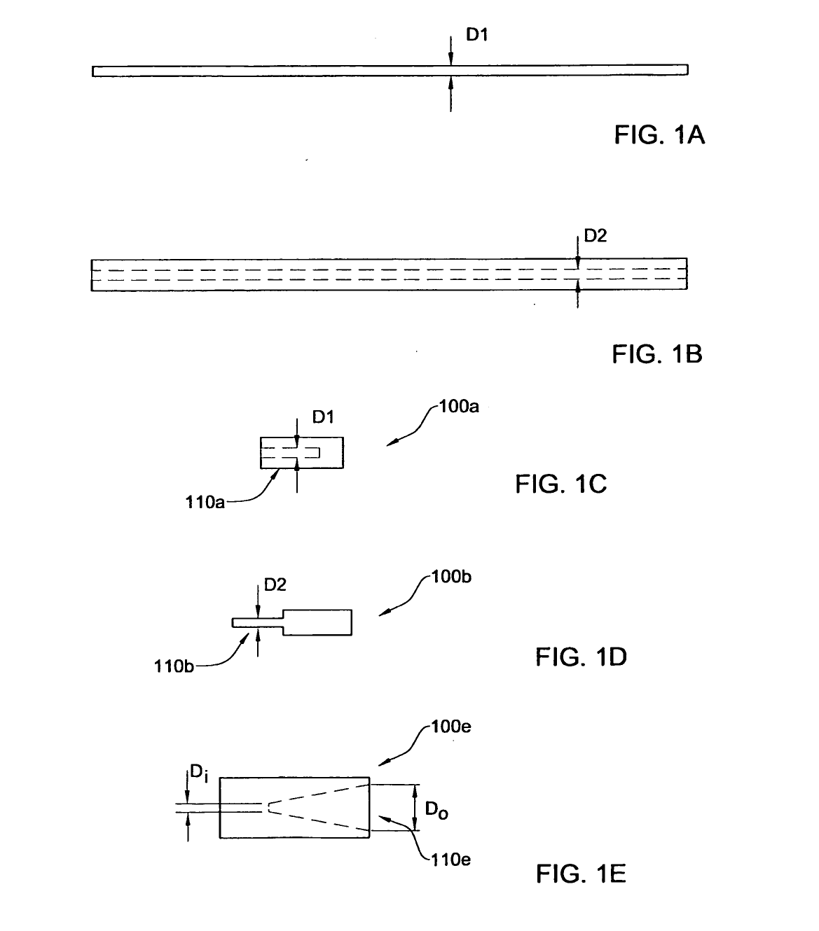

FIGS. 1A and 1B show edible elements, in this example being in the form of a string. The string can be, for example, an off-the-shelf pasta string or string-like tube.

FIGS. IC and ID show examples of toy articles 100 and 100b according to the presently disclosed subject matter, with exemplary female or male connection ends 110a and 110b configured for connection with the edible elements in FIGS. 1A and 1B, respectively.

In FIG. 1E there is illustrated another example of a toy article 100e according to the presently disclosed subject matter, with an exemplary tapering female connection portion 110e, suitable for coupling thereto a male type connection end (e.g. a pasta rod), wherein the connection portion 110e has a tapping receptacle with an inner diameter Dᵢ and an outer diameter Dₒ, thus rendering it suitable for receiving and connecting any edible element with a diameter or a circumcircle diameter substantially extending within the range between Dᵢ and Dₒ.

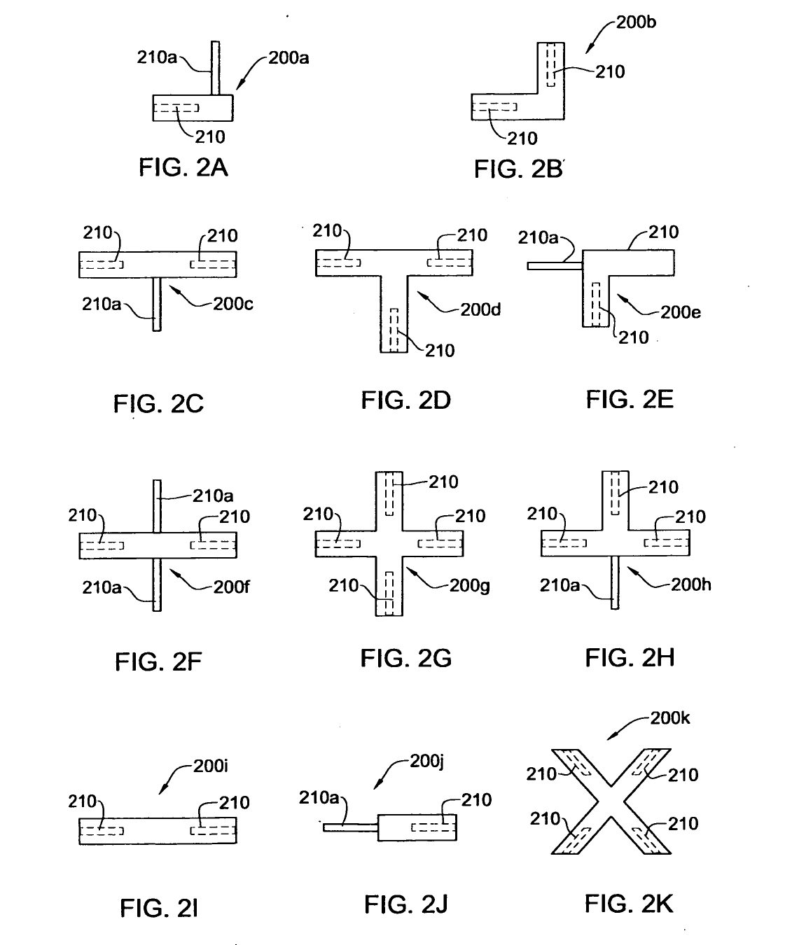

FIGS. 2A to 2K show different examples of toy articles 200a to 200k according to the presently disclosed subject matter, having female connection ends 210 and/or male connection ends 210a.

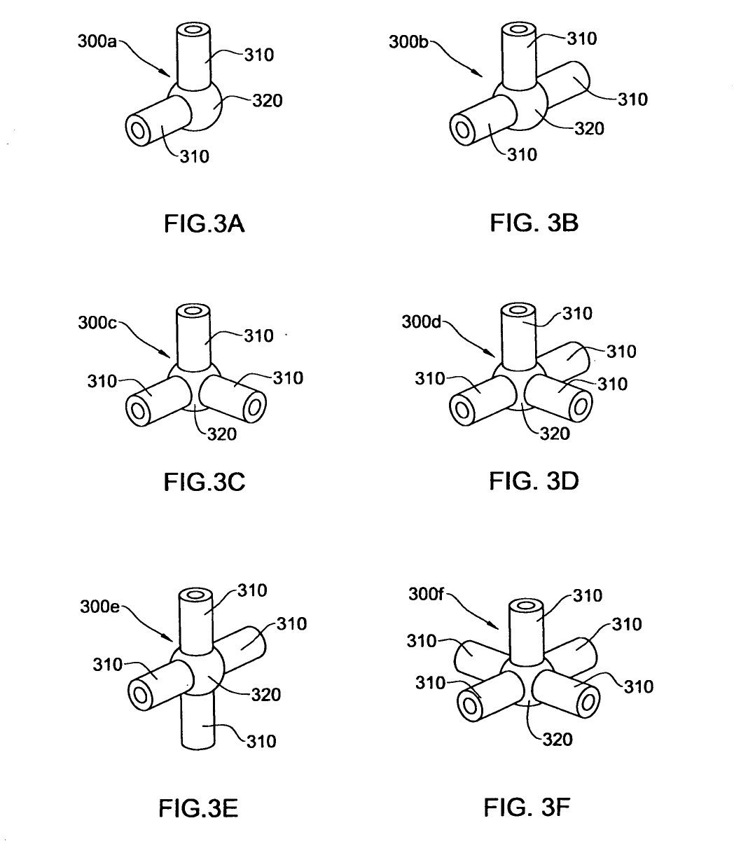

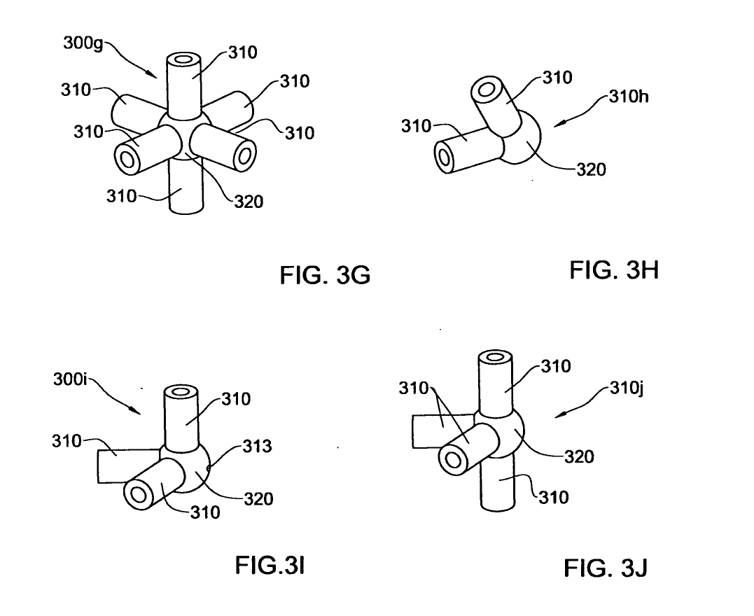

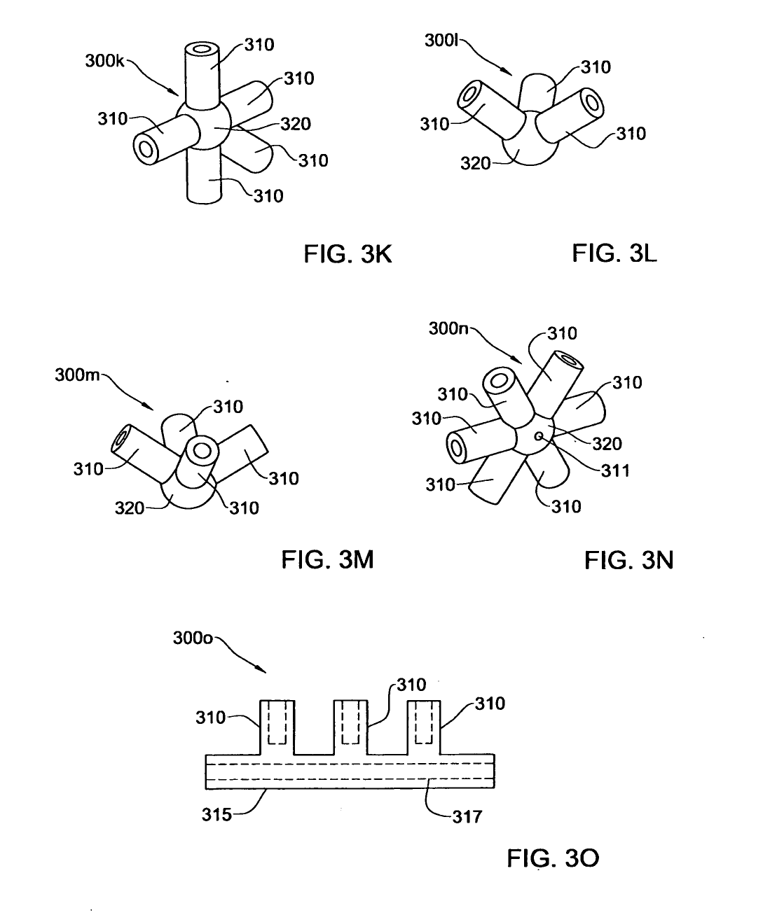

FIGS. 3A to 3O show further examples of toy articles 300a to 300n according to the presently disclosed subject matter. The toy articles 300a to 300n, generally, have connection portions 310 and a spherical base 320. In FIGS. 3A to 3G the toy articles 300a to 300g have between one and six connection ends 310 that extend from the spherical base 320 at right angles to each other. In FIGS. 3H to 3N, the toy articles 300h to 300n have between two and six connection ends 310 extending from the spherical base 320 at various arbitrary angles with respect to each other. For many examples of constructions of interest that can be assembled with the help of the toy articles of the presently disclosed subject matter, the following angles between the connection ends are of particular interest: 30, 45 and 60 degrees, plus or minus 90 degrees multiplied by a whole number (in a range of −3 to 0 to +3).

In the example of FIG. 3I the toy article 300i is configured with a coupling portion 313 at the spherical base 320, coextending with the coupling bore of opposite connection ends 310.

In the example of FIG. 3N the toy article 300n is configured with a coupling portion 311 at the spherical base 320.

FIG. 3O illustrates yet an example of a toy article 300o according to the present disclosed subject matter, wherein several connection portions 310 extend from a tubular body 315, further configured with a thoroughgoing bore serving as a connection portion 317, at opposite ends of the tubular body 315.

FIG. 4 shows a model of a house assembled by using pasta and exemplary toy articles 300d and toy articles 300p.

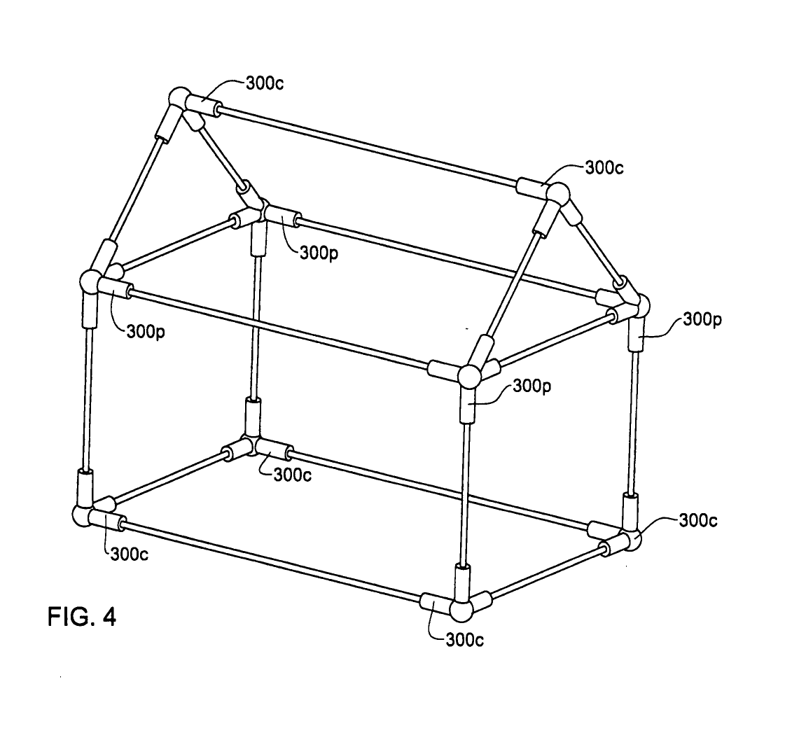

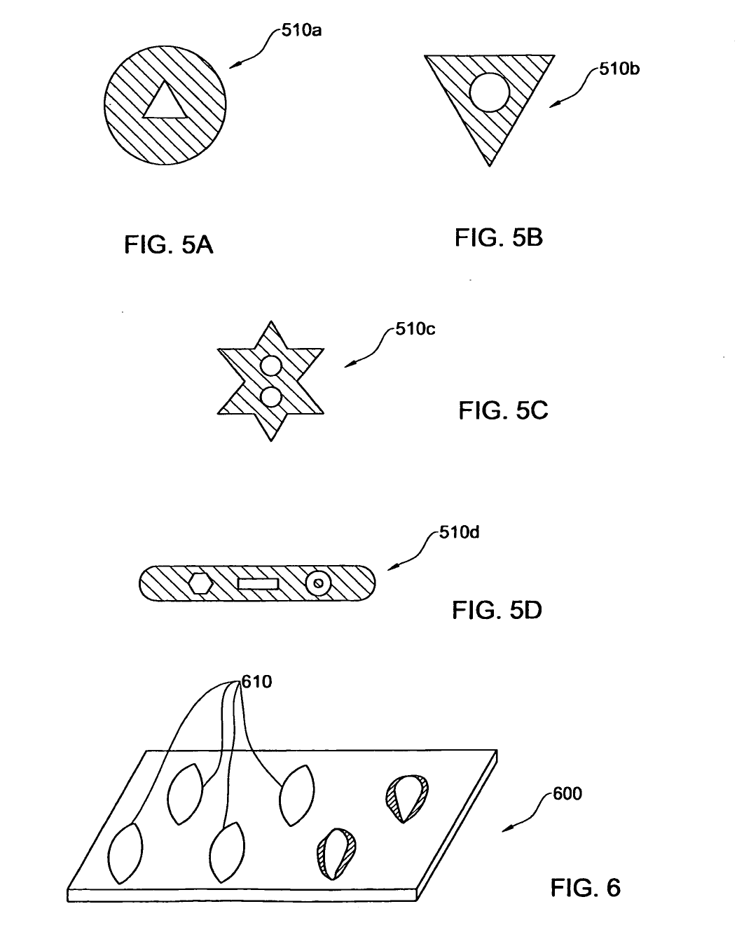

FIGS. 5A to 5D show cross-sections of connector portions 510a to 510d of some further examples of toy articles according to the presently disclosed subject matter. The connector portions 510a to 510d are shown as having different shapes and configured for insertion therein of pasta having cross-sections of corresponding different shapes. In FIGS. 5C and 5D several pasta are connectable to the connection end 500c and 500d in parallel. In an alternative, the shapes, attributed above to pasta intended for insertion in the connection ends 500a to 500d, can be shapes of some exemplary protrusions extending as continuations of the connector portions 510a to 500d, similar to the cases in FIGS. 1B, 2A, 2C, 2E, 2F, 2H and 2J.

FIG. 6 shows an exemplary toy article 600 in the form of a rectangular plate with connection ends 610 configured in shape for placement therein of pasta in the form of shells. The shells are placed in the toy article 600 with their open sides directed upwards, which during enables filling of the shells prior to cooking them together with the toy article 600.

Those skilled in the art to which this invention pertains will readily appreciate that numerous changes, variations, and modifications can be made without departing from the scope of the invention, mutatis mutandis.

1. A toy article comprising at least one connection element and being made of a material configured to be rigid when in a dry state and flexible after being wetted, and being edible.

2. The toy article of claim 1, comprising at least one connection end configured for connection to at least one edible element.

3. The toy article of claim 1 being made of pasta.

4. The toy article of claim 2, wherein the edible element is pasta.

5. The toy article of claim 1, wherein the toy article is edible after cooking thereof.

6. The toy article of claim 2, wherein after articulating an edible element to the connection portion and wetting, the toy article becomes adhered to the edible element.

7. The toy article of claim 2, wherein more force is required to disconnect the edible element from the connection end after it is wetted than when it is dry.

8. The toy article of claim 2, wherein the connection end does not adhere to the edible element when it is dry and at least partially adheres to the edible element after it is wetted.

9. The toy article of claim 1, wherein the toy article is part of a toy article set comprising a plurality of toy articles and edible elements.

10. The toy article of claim 8, wherein the toy article set is packaged separately from or together with the edible elements.

11. The toy article of claim 2, wherein the connection end is configured with a tapering receptacle.

12. The toy article of claim 1, made of a dough comprising sugar, rice or flour.

13. The toy article of claim 2 being made of pasta.

14. The toy article of claim 2, made of a dough comprising sugar, rice or flour.
